(19) United States
(12) Patent Application Publication
(10) Pub. No.: US 2014/0306613 A1
(43) Pub. Date: Oct. 16, 2014

(54) LIGHT-EMITTING DIODE DRIVING APPARATUS

(71) Applicant: Power Forest Technology Corporation, Hsinchu (TW)

(72) Inventors: Fu-Yuan Shih, New Taipei City (TW); Wen-Sheng Wang, Taoyuan County (TW)

(73) Assignee: Power Forest Technology Corporation, Hsinchu (TW)

(21) Appl. No.: 13/958,625

(22) Filed: Aug. 5, 2013

(30) Foreign Application Priority Data
Apr. 16, 2013 (TW) 102113487

(51) Int. Cl. H05B 33/08

(52) U.S. Cl. CPC H05B 33/0815; H05B 33/0851
USPC 315/186

(57) ABSTRACT

A light-emitting-diode (LED) driving apparatus including an AC-DC power conversion stage, a balance circuit and a pulse-width-modulation (PWM) control unit is provided. In the present invention, the LED driving apparatus balances currents flowing through all LED strings by using the balance circuit such that a purpose of current matching is achieved accordingly. In addition, the LED driving apparatus may control the PWM control unit according to an equation between an independent DC output voltage generated by the AC-DC power conversion stage and a control voltage provided by the balance circuit without adopting any boost converter so as to indirectly change a DC output voltage used for directly driving all LED strings and generated by the AC-DC power conversion stage. In this way, the purpose of low cost and high efficiency can be achieved accordingly.

### CROSS-REFERENCE TO RELATED APPLICATION

This application claims the priority benefit of Taiwan application serial no. 102113487, filed on Apr. 16, 2013. The entirety of the above-mentioned patent application is hereby incorporated by reference herein and made a part of this specification.

### BACKGROUND

1. Technical Field

The invention relates to a light-emitting diode (LED) driving apparatus. Particularly, the invention relates to an LED driving apparatus having features of current matching, low cost, high efficiency and high stability.

2. Related Art

In recent years, along with quick development of semiconductor technology, portable electronic products and flat panel display products are accordingly developed. In various types of the flat panel display, a liquid crystal display (LCD) has become a main stream in various display products due to its advantages of low voltage operation, no irradiation, light weight, small volume, etc. Generally, since an LCD panel is not self-luminous, a backlight module has to be disposed under the LCD panel to provide a light source for the LCD panel.

Conventional backlight modules are approximately divided into two types, and one type is the backlight module composed of cold cathode fluorescent lamps (CCFLs), and the other type is the backlight module composed of light-emitting diodes (LEDs). Since the LED backlight module may enhance a color gamut of the LCD, various display panel manufacturers generally use the LED backlight module to replace the CCFL backlight module.

Generally, as that shown in FIG. 1A, an LED backlight module 50 has a plurality of LED strings (not shown) arranged in parallel, and each of the LED strings is composed of a plurality of LEDs connected in series. In an actual application, an alternating current (AC)-direct current (DC) power conversion stage 30 is generally used to first convert an AC input voltage V_{AC} into a low DC output voltage V_{LOW}, and then a boost converter 40 is used to boost the low DC output voltage V_{LOW} into a high DC output voltage V_{HIGH} capable of simultaneously driving each of the LED strings.

Since a hardware configuration of a driving apparatus used for driving the LED backlight module 50 is generally the AC-DC power conversion stage 30 in collaboration with the boost converter 40, the hardware cost of such driving apparatus is relatively high, and since the additional boost converter 40 is used, efficiency of the driving apparatus is lower.

### SUMMARY

Accordingly, the invention is directed to a light-emitting diode (LED) driving apparatus, which is capable of driving one or a plurality of LED strings arranged in parallel in an LED backlight module without using any boost converter, and also has features of low cost, high stability and high efficiency, and maintains original current matching (i.e. the current flowing through each LED string is the same (current balance)).

To achieve one of or all aforementioned and other advantages, an embodiment of the invention provides a light-emitting diode (LED) driving apparatus including an AC-DC power conversion stage, which is configured to receive an AC input voltage, and convert the AC input voltage according to a pulse-width-modulation (PWM) signal, so as to generate a first DC output voltage and a second DC output voltage having a ratio relationship, where the first DC output voltage is configured to simultaneously drive a plurality of LED strings connected in parallel. The LED driving apparatus also includes a balance circuit, which is coupled to the LED strings, and is configured to balance currents flowing through the LED strings, and adaptively adjust voltage drops of the LED strings under a fixed current source, so as to output a control voltage. The LED driving apparatus further includes a PWM control unit, which is coupled to the AC-DC power conversion stage and the balance circuit, and is configured to receive the control voltage and the second DC output voltage, and generate the PWM signal to the AC-DC power conversion stage.

According to the above descriptions, the LED driving apparatus of the invention uses a balance circuit to balance the currents flowing through all of the LED strings such that the purpose of current matching is achieved accordingly. In addition, the LED driving apparatus may control the PWM control unit according to an equation between an independent DC output voltage (i.e. the second DC output voltage) generated by the AC-DC power conversion stage and a control voltage provided by the balance circuit without adopting any boost converter, so as to indirectly change a DC output voltage (i.e. the first DC output voltage) which is used for directly driving all LED strings and generated by the AC-DC power conversion stage based on the second DC output voltage. In this way, the purpose of low cost and high efficiency are achieved accordingly.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of driving a conventional light-emitting diode (LED0 backlight module.

FIG. 1B is a schematic diagram of an LED driving apparatus 10 according to an embodiment of the invention.

FIG. 2 is a schematic diagram of an LED string LLBi (i=1−m) according to an embodiment of the invention.

FIG. 3A is a schematic diagram of an AC-DC power conversion stage 101 according to an embodiment of the invention.

FIG. 3B is a schematic diagram of an AC-DC power conversion stage 101 according to another embodiment of the invention.

FIG. 3C is a schematic diagram of an AC-DC power conversion stage 101 according to another embodiment of the invention.

FIG. 4 is a schematic diagram of a balance circuit 103 according to an embodiment of the invention.

FIG. 5 is a schematic diagram of a PWM control unit 105 according to an embodiment of the invention.

FIG. 6 is a schematic diagram of a feedback unit 501 according to an embodiment of the invention.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

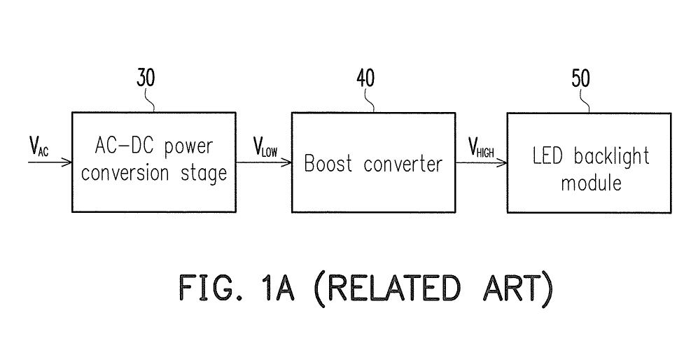

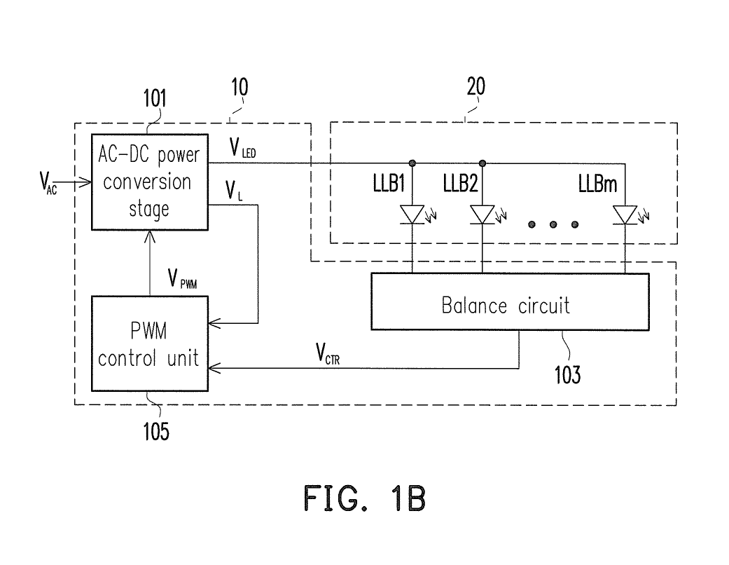

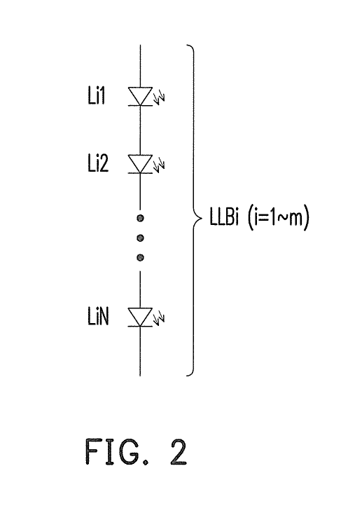

FIG. 1B is a schematic diagram of a light-emitting diode (LED) driving apparatus 10 according to an embodiment of the invention. Referring to FIG. 1B, the LED driving apparatus 10 is at least adapted to drive an LED backlight module 20 of a liquid crystal display (LCD), though the invention is not limited thereto. The LED backlight module 20 has a plurality of LED strings LLBi (i=1−m) arranged in parallel, and each of the LED strings LLBi (i=1−m) is composed of a plurality of LEDs Li1-LiN (i=1−m) connected in series, as that shown in FIG. 2. Moreover, the LED apparatus 10 includes an alternating current (AC)-direct current (DC) power conversion stage 101, a balance circuit 103, and a pulse width modulation (PWM) control unit 105.

In the present embodiment, the AC-DC power conversion stage 101 receives an AC input voltage V_{AC}, and converts the received AC input voltage V_{AC} according to a PWM signal V_{PWM} generated by the PWM control unit 105, so as to generate two DC output voltages V_{LED} and V_{L} both having a ratio relationship, where the DC output voltage V_{LED} is configured to simultaneously drive the LED strings LLBi (i=1−m), and the DC output voltage V_{L} is generally a power of 5V or 3.3V required by the system.

The balance circuit 103 is coupled to the LED strings LLBi (i=1−m), and is configured to balance currents flowing through the LED strings LLBi (i=1−m) (i.e. current matching) and adaptively adjust a voltage drop of each of the LED strings LLBi (i=1−m), so as to output a control voltage V_{CTR}. The PWM control unit 105 is coupled to the AC-DC power conversion stage 101 and the balance circuit 103, and receives the control voltage V_{CTR} output by the balance circuit 103 and the DC output voltage V_{L} generated by the AC-DC power conversion stage 101, and accordingly generates the PWM signal V_{PWM} to the AC-DC power conversion stage 101.

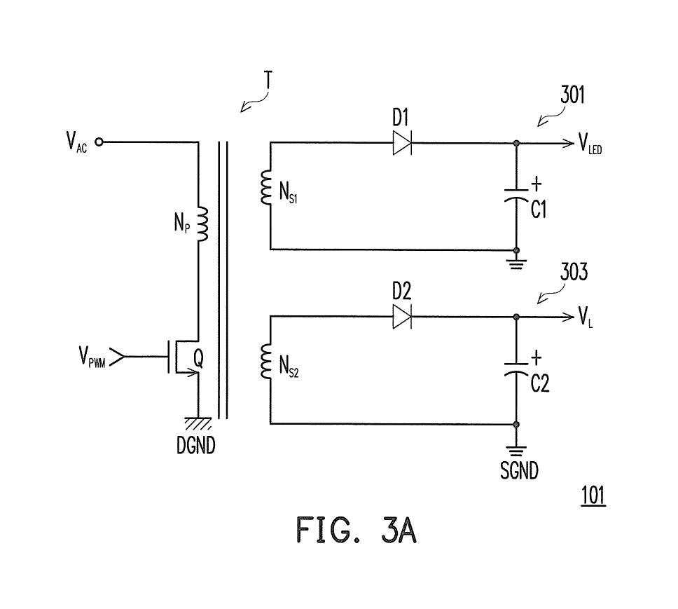

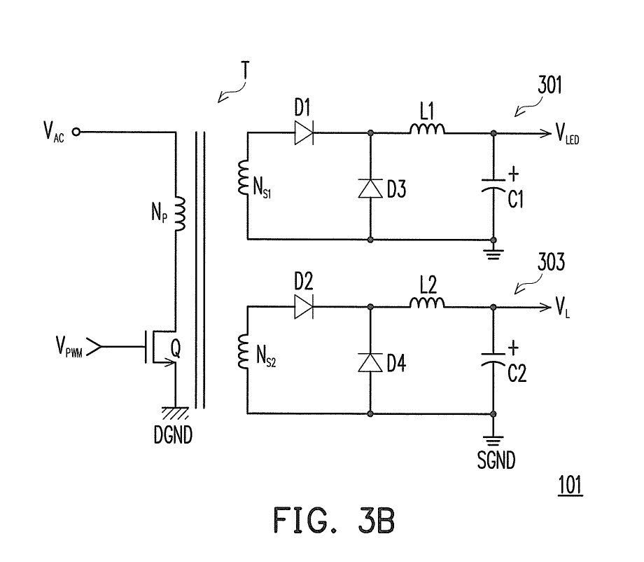

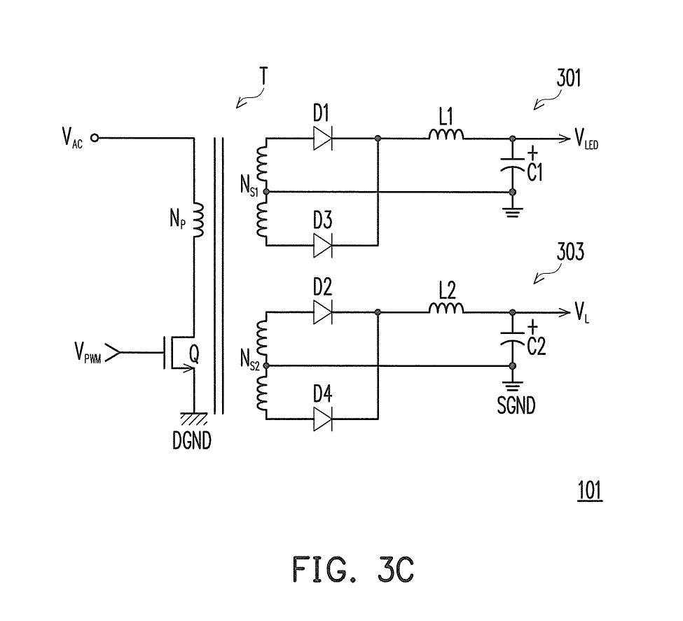

In detail, FIG. 3A is a schematic diagram of the AC-DC power conversion stage 101 according to an embodiment of the invention. Referring to FIG. 3A, the AC-DC power conversion stage 101 includes an isolated transformer T, a power switch Q and rectification-filtering units 301 and 303. The isolated transformer T has a primary side Np and two secondary sides Ns1 and Ns2. A first terminal of the primary side Np of the isolated transformer T is configured to receive the AC input voltage V_{AC}. A first terminal of the power switch Q is coupled to a second terminal of the primary side Np of the isolated transformer T, a second terminal of the power switch Q is coupled to a ground potential (i.e. a dangerous ground) DGND, and a control terminal of the power switch Q is configured to receive the PWM signal V_{PWM} generated by the PWM control unit 105.

The rectification-filtering unit 301 is coupled in parallel with the secondary side Ns1 of the isolated transformer T, and is configured to rectify and filter an AC voltage reflected at the secondary side Ns1 by the AC input voltage V_{AC} received by the primary side Np of the isolated transformer T, so as to output the DC output voltage V_{LED}. Similarly, the rectification-filtering unit 303 is coupled in parallel with the secondary side Ns2 of the isolated transformer T, and is configured to rectify and filter an AC voltage reflected at the secondary side Ns2 by the AC input voltage V_{AC} received by the primary side Np of the isolated transformer T, so as to output the DC output voltage V_{L}.

In the present embodiment, the rectification-filtering unit 301 includes a diode D1 and a capacitor C1, where an anode of the diode D1 is coupled to a first terminal of the secondary side Ns1 of the isolated transformer T, and a cathode of the diode D1 is configured to output the DC output voltage V_{LED}. Moreover, a first terminal of the capacitor C1 is coupled to the cathode of the diode D1, and a second terminal of the capacitor C1 is coupled to another ground potential (i.e. a safe ground) SGND.

Similarly, the rectification-filtering unit 303 includes a diode D2 and a capacitor C2, where an anode of the diode D2 is coupled to a first terminal of the secondary side Ns2 of the isolated transformer T, and a cathode of the diode D2 is configured to output the DC output voltage V_{L}. Moreover, a first terminal of the capacitor C2 is coupled to the cathode of the diode D2, and a second terminal of the capacitor C2 is coupled to the safe ground SGND.

According to the above description, it is known that the AC-DC power converting state 101 of FIG. 3A is a flyback converter. However, the invention is not limited thereto.

FIG. 3B is a schematic diagram of an AC-DC power conversion stage 101 according to another embodiment of the invention. Referring to FIG. 3A and FIG. 3B, compared to the AC-DC power conversion stage 101 of FIG. 3A, the AC-DC power conversion stage 101 of FIG. 3B further includes diodes D3 and D4 and inductors L1 and L2. An anode of the diode D3 is coupled to the safe ground SGND, and a cathode of the diode D3 is coupled to the cathode of the diode D1. Moreover, the inductor L1 is coupled between the cathode of the diode D1 and the first terminal of the capacitor C1. Similarly, an anode of the diode D4 is coupled to the safe ground SND, and a cathode of the diode D4 is coupled to the cathode of the diode D2. Moreover, the inductor L2 is coupled between the cathode of the diode D2 and the first terminal of the capacitor C2.

According to the above description, it is known that the AC-DC power converting state 101 of FIG. 3B is a forward converter. However, the invention is not limited thereto.

FIG. 3C is a schematic diagram of an AC-DC power conversion stage 101 according to another embodiment of the invention. Referring to FIG. 3A and FIG. 3C, compared to the AC-DC power conversion stage 101 of FIG. 3A, the AC-DC power conversion stage 101 of FIG. 3C further includes the diodes D3 and D4 and the inductors L1 and L2, and the secondary sides Ns1 and Ns2 of the isolated transformer T respectively have a first terminal, a second terminal and a center-tapped terminal. The anode of the diode D1 is coupled to the first terminal of the secondary side Ns1 of the isolated transformer T. A first terminal of the inductor L1 is coupled to the cathode of the diode D1, and a second terminal of the inductor L1 is configured to output the DC output voltage V_{LED}. The first terminal of the capacitor C1 is coupled to the second terminal of the inductor L1, and the second terminal of the capacitor C1 is coupled to the center-tapped terminal of the secondary side Ns1 of the isolated transformer T and the safe ground SGND. The anode of the diode D3 is coupled to the second terminal of the secondary side Ns1 of the isolated transformer T, and the cathode of the diode D3 is coupled to the cathode of the diode D1.

Similarly, the anode of the diode D2 is coupled to the first terminal of the secondary side Ns2 of the isolated transformer T. A first terminal of the inductor L2 is coupled to the cathode of the diode D2, and a second terminal of the inductor L2 is configured to output the DC output voltage V_{L}. The first terminal of the capacitor C2 is coupled to the second terminal of the inductor L2, and the second terminal of the capacitor C2 is coupled to the center-tapped terminal of the secondary side Ns2 of the isolated transformer T and the safe ground SGND. The anode of the diode D4 is coupled to the second terminal of the secondary side Ns2 of the isolated transformer T, and the cathode of the diode D4 is coupled to the cathode of the diode D2.

According to the above description, it is known that the AC-DC power converting state 101 of FIG. 3C is a bridge/push-pull converter.

According to the above descriptions, the ratio relationship between the two DC output voltages V_{LED} and V_{L} generated by the AC-DC power conversion stage 101 can be represented by a following equation 1:

V_{LED}/Ns1=V_{L}/Ns2 equation 1

Therefore, the ratio relationship between the two DC output voltages V_{LED} and V_{L} generated by the AC-DC power conversion stage 101 is a winding turns ratio of the two secondary sides Ns1 and Ns2 of the isolated transformer T.

On the other hand, in another embodiment of the invention, the balance circuit 103 is further capable of receiving an external dimming signal DS (which is a PWM signal) to adjust a brightness of each of the LED strings LLBi (i=1−m).

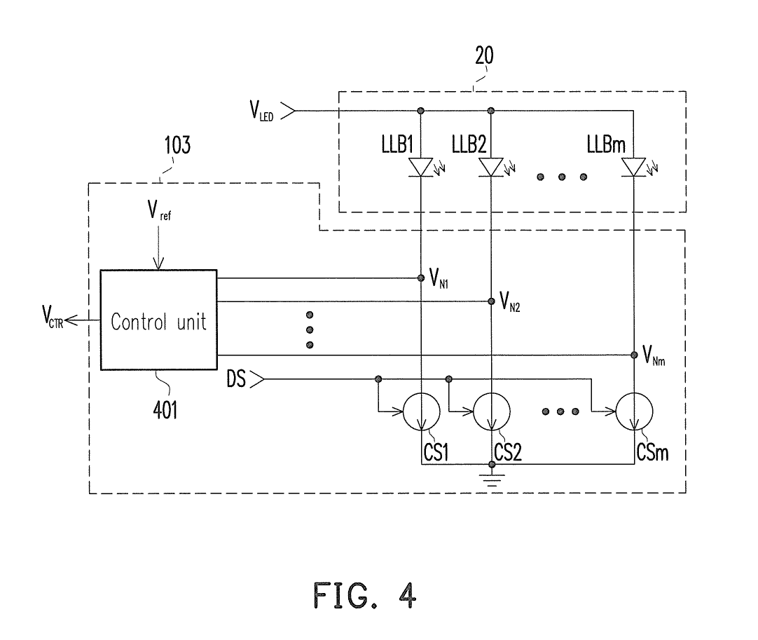

In this way, FIG. 4 is a schematic diagram of the balance circuit 103 according to an embodiment of the invention. Referring to FIG. 4, the balance circuit 103 includes a plurality of controllable current sources CSi (i=1−m) and a control unit 401. The controllable current sources CSi (i=1−m) can be respectively/synchronously controlled by the external dimming signal DS, and an controllable current source CSi is coupled between an i^{th} LED string LLBi and the safe ground SGND.

For example, a first controllable current source CS1 is coupled between a first LED string LLB1 and the safe ground SGND, a second controllable current source CS2 is coupled between a second LED string LLB2 and the safe ground SGND, and deduced by analogy, an m^{th} controllable current source CSm is coupled between an m^{th} LED string LLBm and the safe ground SGND.

Moreover, the control unit 401 is coupled to the controllable current sources CSi (i=1−m), and is configured to select a minimum voltage drop of the controllable current sources CSi (i=1−m) to serve as the control voltage V_{CTR} according to a reference voltage Vref. In other words, the control unit 40 receives node voltages V_{Ni} (i=1−m) (i.e. voltage drops of the controllable current sources CSi (i=1−m)), and compares the same with the reference voltage Vref to select the minimum one of the node voltages V_{Ni} (i=1−m) to serve as the control voltage V_{CTR}, i.e., V_{CTR}=Vmin{V_{Ni} (i=1−m)}.

It should be noticed that the controllable current source CSi (i=1−m) must have enough voltage drop to maintain a constant current source. However, since a load characteristic of each LED string LLBi (i=1−m) is probably different, different LED strings LLBi (i=1−m) cause different voltage drops on the corresponding controllable current sources CSi (i=1−m). Therefore, an excessively large voltage drop may cause larger power dissipation of the controllable current source CSi (i=1−m), so as to decrease the efficiency of the controllable current source CSi (i=1−m).

Accordingly, in the present embodiment, a reason of taking the minimum voltage drop of the controllable current source CSi (i=1−m) as the control voltage V_{CTR} is to avoid the controllable current source CSi (i=1−m) to produce excessively large power dissipation. Therefore, the spirit of the invention is met as long as the DC output voltage V_{LED} generated by the AC-DC power conversion stage 101 makes the controllable current sources CSi (i=1−m) to have enough voltage drops to maintain the constant current sources. Certainly, in other embodiments of the invention, a maximum voltage drop of the controllable current sources CSi (i=1−m) or an average voltage drop of the controllable current sources CSi (i=1−m) can also be used to serve as the control voltage V_{CTR} in different applications, which is determined according to an actual design requirement.

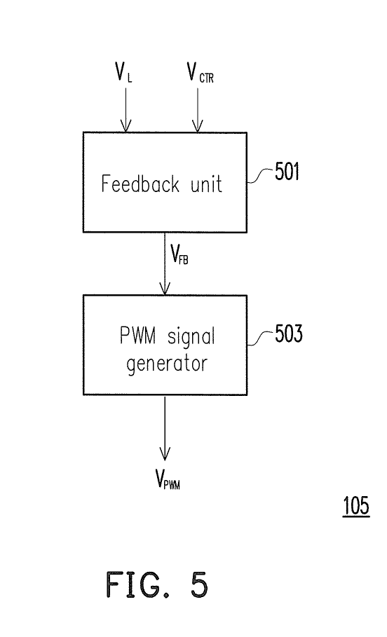

Moreover, FIG. 5 is a schematic diagram of the PWM control unit 105 according to an embodiment of the invention. Referring to FIG. 5, the PWM control unit 105 includes a feedback unit 501 and a PWM signal generator 503. The feedback unit 501 is configured to receive the control voltage V_{CTR} output by the balance circuit 103 and the DC output voltage V_{L} generated by the AC-DC power conversion stage 101, and outputs a feedback signal V_{FB} according to an equation (which is described later) between the received control voltage V_{CTR} and the DC output voltage V_{L}. Moreover, the PWM signal generator 503 is coupled to the feedback unit 501, and adaptively outputs and adjusts the PWM signal V_{PWM} (for example, adjust a duty cycle of the PWM signal V_{PWM}) according to the feedback signal V_{FB} output by the feedback unit 501, so as to switch (i.e. turn on/off) the power switch Q.

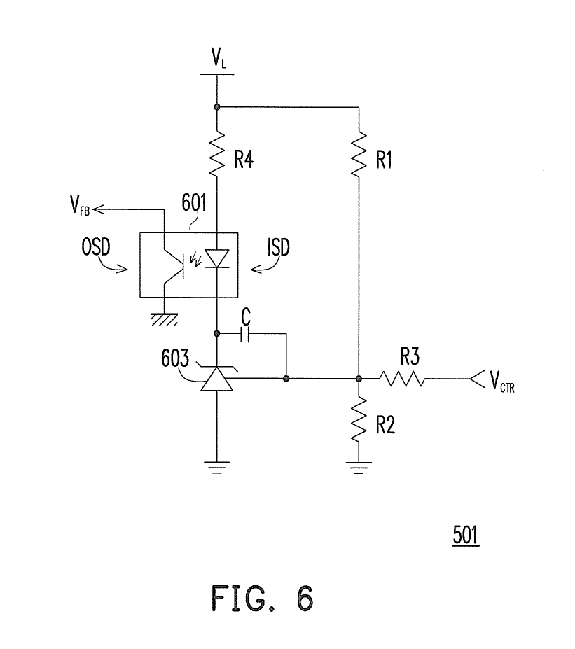

In detail, FIG. 6 is a schematic diagram of the feedback unit 501 according to an embodiment of the invention. Referring to FIG. 5 and FIG. 6, the feedback unit 501 includes resistors R1-R4, a photo-coupler 601, a capacitor C and a regulator 603. A first terminal of the resistor R1 is configured to receive the DC output voltage V_{L} generated by the AC-DC power conversion stage 101. A first terminal of the resistor R2 is coupled to a second terminal of the resistor R1, and a second terminal of the resistor R2 is coupled to the safe ground SGND. A first terminal of the resistor R3 is configured to receive the control voltage V_{CTR} output by the balance circuit 103, and a second terminal of the resistor R3 is coupled to the second terminal of the resistor R1. A first terminal of the resistor R4 is configured to receive the DC output voltage V_{L} generated by the AC-DC power conversion stage 101.

The photo-coupler 601 has an input side ISD and an output side OSD. A first terminal of the input side ISD of the photo-coupler 601 is coupled to the second terminal of the resistor R4, a first terminal of the output side OSD of the photo-coupler 601 is configured to output the feedback signal V_{FB}, and a second terminal of the output side OSD of the photo-coupler 601 is coupled to the dangerous ground DGND. A first terminal of the capacitor C is coupled to a second terminal of the input side ISD of the photo-coupler 601, and a second terminal of the capacitor C is coupled to the second terminal of the resistor R1. It should be noticed that, a bias required by the photo-coupler 601 is provided by the resistor R4.

In the present embodiment, the regulator 603 may use an integrated circuit (IC) with a referential number of TL431, though the invention is not limited thereto. A positive terminal (which is also referred to as an anode) of the regulator 603 is coupled to the safe ground SGND, a negative terminal (which is also referred to as a cathode) of the regulator 603 is coupled to the second terminal of the input side ISD of the photo-coupler 601, and a reference input terminal of the regulator 603 is coupled to the second terminal of the resistor R1.

According to the above description, the equation between the control voltage V_{CTR} and the DC output voltage V_{L} received by the feedback unit 501 can be represented by a following equation 2:

K=A*V_{L}+B*V_{CTR} equation 2

Where, K is a predetermined value, and is a reference voltage (i.e. 2.5V) built in the regulator 603;

A is a coefficient, which can be represented as A=R1/[R1+(R2//R3)], and R1-R3 are respectively resistance values of the resistors R1-R3;

B is another coefficient, which can be represented as B=R3/[R3+(R1//R2)];

V_{L} is a voltage value of the DC output voltage V_{L}; and

V_{CTR} is a voltage value of the control voltage V_{CTR}.

Therefore, the equation 2 can be changed to a following equation 3:

2.5V=R1/[R1+(R2//R3)]*V_{L}+R3/[R3+(R1//R2)]*V_{CTR} equation 3

In this way, when the control voltage V_{CTR} output by the balance circuit 103 is higher than 2.5V, it represents that the DC output voltage V_{LED} generated by the AC-DC power conversion stage 101 is excessively high. Therefore, according to the equation (i.e. the equation 2) between the control voltage V_{CTR} and the DC output voltage V_{L} received by the feedback unit 501, it is known that the DC output voltage V_{L} has to be decreased when the control voltage V_{CTR} is increased. Therefore, the duty cycle of the PWM signal V_{PWM} generated by the PWM signal generator 503 is narrowed/decreased in response to the feedback signal V_{FB} output by the feedback unit 501, so as to decrease the DC output voltage V_{L}. On the other hand, since the ratio relationship between the two DC output voltages V_{LED} and V_{L} generated by the AC-DC power conversion stage 101 is the winding turns ratio of the two secondary sides Ns1 and Ns2 of the isolated transformer T, once the DC output voltage V_{L} is decreased, the DC output voltage V_{LED} is also decreased. Therefore, the control voltage V_{CTR} output by the balance circuit 103 is accordingly decreased, and is stabilized to 2.5V.

Conversely, when the control voltage V_{CTR} output by the balance circuit 103 is lower than 2.5V, it represents that the DC output voltage V_{LED} generated by the AC-DC power conversion stage 101 is excessively low. Therefore, according to the equation (i.e. the equation 2) between the control voltage V_{CTR} and the DC output voltage V_{L} received by the feedback unit 501, it is known that the DC output voltage V_{L} has to be increased when the control voltage V_{CTR} is decreased. Therefore, the duty cycle of the PWM signal V_{PWM} generated by the PWM signal generator 503 is broadened/increased in response to the feedback signal V_{FB} output by the feedback unit 501, so as to increase the DC output voltage V_{L}. On the other hand, since the ratio relationship between the two DC output voltages V_{LED} and V_{L} generated by the AC-DC power conversion stage 101 is the winding turns ratio of the two secondary sides Ns1 and Ns2 of the isolated transformer T, once the DC output voltage V_{L} is increased, the DC output voltage V_{LED} is also increased. Therefore, the control voltage V_{CTR} output by the balance circuit 103 is accordingly increased, and is stabilized to 2.5V.

In summary, the LED driving apparatus of the invention uses a balance circuit to balance the currents flowing through all of the LED strings such that the purpose of current matching is achieved accordingly (since the current flowing through each of the LEDs is the same). In addition, the LED driving apparatus may control the PWM control unit according to an equation between an independent DC output voltage (V_{L}) generated by the AC-DC power conversion stage and a control voltage (V_{CTR}) provided by the balance circuit without adopting any boost converter, so as to indirectly change a DC output voltage (V_{LED}) used for directly driving all LED strings and generated by the AC-DC power conversion stage (i.e. an indirect manner of changing the DC output voltage V_{LED} by changing the DC output voltage V_{L}). In this way, the purpose of low cost (since no boost converter is used), high efficiency and high stability (due to that a load variation of the DC output voltage V_{L} is smaller and stable compared to that of the DC output voltage V_{LED}) are achieved accordingly.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A light-emitting diode (LED) driving apparatus, comprising:
an alternating current (AC)-direct current (DC) power conversion stage, configured to receive an AC input voltage, and convert the AC input voltage according to a pulse-width-modulation (PWM) signal, so as to generate a first DC output voltage and a second DC output voltage both having a ratio relationship, wherein the first DC output voltage is configured to simultaneously drive a plurality of LED strings connected in parallel;
a balance circuit, coupled to the LED strings, configured to balance currents flowing through the LED strings, and adaptively adjust voltage drops of the LED strings, so as to output a control voltage; and
a PWM control unit, coupled to the AC-DC power conversion stage and the balance circuit, configured to receive the control voltage and the second DC output voltage, and accordingly generate the PWM signal to the AC-DC power conversion stage.

2. The LED driving apparatus as claimed in claim 1, wherein the AC-DC power conversion stage comprises:
an isolated transformer, having a primary side, a first secondary side and a second secondary side, wherein a first terminal of the primary side is configured to receive the AC input voltage;
a power switch, having a first terminal coupled to a second terminal of the primary side, a second terminal coupled to a first ground potential, and a control terminal configured to receive the PWM signal;
a first rectification-filtering unit, coupled in parallel with the first secondary side, and configured to rectify and filter an AC voltage reflected at the first secondary side by the AC input voltage received by the primary side, so as to output the first DC output voltage; and
a second rectification-filtering unit, coupled in parallel with the second secondary side, and configured to rectify and filter an AC voltage reflected at the second secondary side by the AC input voltage received by the primary side, so as to output the second DC output voltage.

3. The LED driving apparatus as claimed in claim 2, wherein the first rectification-filtering unit comprises:
a first diode, having an anode coupled to a first terminal of the first secondary side, and a cathode configured to output the first DC output voltage; and
a first capacitor, having a first terminal coupled to the cathode of the first diode, and a second terminal coupled to a second ground potential.

4. The LED driving apparatus as claimed in claim 3, wherein the second rectification-filtering unit comprises:
a second diode, having an anode coupled to a first terminal of the second secondary side, and a cathode configured to output the second DC output voltage; and
a second capacitor, having a first terminal coupled to the cathode of the second diode, and a second terminal coupled to the second ground potential.

5. The LED driving apparatus as claimed in claim 4, wherein the first rectification-filtering unit further comprises:
a third diode, having an anode coupled to the second ground potential, and a cathode coupled to the cathode of the first diode; and
a first inductor, coupled between the cathode of the first diode and the first terminal of the first capacitor.

6. The LED driving apparatus as claimed in claim 5, wherein the second rectification-filtering unit further comprises:
a fourth diode, having an anode coupled to the second ground potential, and a cathode coupled to the cathode of the second diode; and
a second inductor, coupled between the cathode of the second diode and the first terminal of the first capacitor.

7. The LED driving apparatus as claimed in claim 2, wherein the first secondary side and the second secondary side respectively have a first terminal, a second terminal and a center-tapped terminal.

8. The LED driving apparatus as claimed in claim 7, wherein the first rectification-filtering unit comprises:
a first diode, having an anode coupled to the first terminal of the first secondary side;
a first inductor, having a first terminal coupled to a cathode of the first diode, and a second terminal configured to output the first DC output voltage;
a first capacitor, having a first terminal coupled to the second terminal of the first inductor, and a second terminal coupled to the center-tapped terminal of the first secondary side and a second ground potential; and
a second diode, having an anode coupled to the second terminal of the first secondary side, and a cathode coupled to the cathode of the first diode.

9. The LED driving apparatus as claimed in claim 8, wherein the second rectification-filtering unit comprises:
a third diode, having an anode coupled to the first terminal of the second secondary side;
a second inductor, having a first terminal coupled to a cathode of the third diode, and a second terminal configured to output the second DC output voltage;
a second capacitor, having a first terminal coupled to the second terminal of the second inductor, and a second terminal coupled to the center-tapped terminal of the second secondary side and the second ground potential; and
a fourth diode, having an anode coupled to the second terminal of the second secondary side, and a cathode coupled to the cathode of the third diode.

10. The LED driving apparatus as claimed in claim 2, wherein the ratio relationship is a winding turns ratio of the first secondary side and the second secondary side.

11. The LED driving apparatus as claimed in claim 2, wherein the balance circuit is further capable of receiving a dimming signal and adjusting brightness of the LED strings.

12. The LED driving apparatus as claimed in claim 10, wherein the balance circuit comprises:
a plurality of controllable current sources, controlled by the dimming signal, wherein an i^{th} controllable current source is coupled between an i^{th} LED string and a second ground potential, and i is a positive integer; and
a control unit, coupled to the controllable current sources, and configured to select a minimum voltage drop of the controllable current sources to serve as the control voltage according to a reference voltage.

13. The LED driving apparatus as claimed in claim 2, wherein the PWM control unit comprises:
a feedback unit, configured to receive the control voltage and the second DC output voltage, and output a feedback signal according to an equation between the received control voltage and the second DC output voltage; and
a PWM signal generator, coupled to the feedback unit, and configured to adaptively output and adjust the PWM signal according to the feedback signal.

14. The LED driving apparatus as claimed in claim 13, wherein the equation is K=A*V_{L}+B*V_{CTR},
wherein K is a predetermined value;
A and B are respectively a coefficient;
V_{L} is a voltage value of the second DC output voltage; and
V_{CTR} is a voltage value of the control voltage.

15. The LED driving apparatus as claimed in claim 14, wherein the feedback unit comprises:
a first resistor, having a first terminal receiving the second DC output voltage;
a second resistor, having a first terminal coupled to a second terminal of the first resistor, and a second terminal coupled to a second ground potential;
a third resistor, having a first terminal receiving the control voltage, and a second terminal coupled to the second terminal of the first resistor;
a fourth resistor, having a first terminal receiving the second DC output voltage;
a photo-coupler, having an input side and an output side, wherein a first terminal of the input side is coupled to a second terminal of the fourth resistor, a first terminal of the output side is configured to output the feedback signal, and a second terminal of the output side is coupled to the first ground potential;
a capacitor, having a first terminal coupled to a second terminal of the input side, and a second terminal coupled to the second terminal of the first resistor; and
a regulator, having a positive terminal coupled to the second ground potential, a negative terminal coupled to the second terminal of the input side, and a reference input terminal coupled to the second terminal of the first resistor.

16. The LED driving apparatus as claimed in claim 15, wherein the regulator is an integrated circuit.

17. The LED driving apparatus as claimed in claim 16, wherein a referential number of the integrated circuit is TL431.

18. The LED driving apparatus as claimed in claim 17, wherein:
the predetermined value is a reference voltage built in the regulator;
A=R1/[R1+(R2//R3)]; and
B=R3/[R3+(R1//R2)],
wherein R1-R3 are respectively resistance values of the first to the third resistors.
